(19) United States
(12) Patent Application Publication
(10) Pub. No.: US 2006/0032462 A1
(43) Pub. Date: Feb. 16, 2006

(54) Pet Waterproof Disposable Vinyl Jacket

(76) Inventor: Young Jun Kim, Edgewater, NJ (US)

Correspondence Address: YOUNG JUN KIM, 1055 RIVER ROAD, APT 301S, EDGEWATER, NJ, 07020, US

(21) Appl. No.: 10/710,559

(22) Filed: Jul. 20, 2004

(51) Int. Cl. A01K 13/00

(52) U.S. Cl. 119/850

(57) ABSTRACT

A practical and disposable pet jacket to use when conditions are rainy, windy or cold and discharge after use, it will minimize contamination after walk.

### DETAILED DESCRIPTION

The vinyl jacket is made for pets to provide protection in bad weather conditions, is made in vinyl, easy to fit and disposable over wich the invention is applied.

It is desirable for pets owners mantain dry, warm and clean to his pets during and after walking, wich in conventional pets clothing has to be laundry to maintain clean and avoid home contamination from outside. The protective vinyl is worn over the head and the back leg is inserted into the cut and tied in tha chest to keep covered in wind conditions.

The use of vinyl material for this invention is responsible on its own, for providing protection, low cost and flexibility in sizes from small to large pets.

1. A easy fit disposable jacket made for pets.
